(19) United States
(12) Patent Application Publication
(10) Pub. No.: US 2011/0112991 A1
(43) Pub. Date: May 12, 2011

(54) METHOD OF IDENTIFYING CO2 REDUCTION AND OBTAINING CARBON CREDITS

(76) Inventors: Paul Raymond Scheid, West Hartford, CT (US); Colin Karsten, Avon, CT (US); William J. Welch, Madison, CT (US); Anupam Bhargava, Simsbury, CT (US)

(21) Appl. No.: 13/003,886

(22) PCT Filed: Jul. 24, 2009
(86) PCT No.: PCT/US09/51635

§ 371 Date: Jan. 13, 2011

Related U.S. Application Data
(60) Provisional application No. 61/083,654, filed on Jul. 25, 2008.

(51) Int. Cl. G06Q 90/00

(52) U.S. Cl. 705/500

(57) ABSTRACT

A method comprises the step of certifying a savings in carbon emission based upon a cleaning of a gas turbine engine.

### RELATED APPLICATIONS

This application is the U.S. national phase of PCT/US2009/05163, filed Jul. 24, 2009, which claims priority to U.S. Provisional Application No. 61/083,654, which was filed on Jul. 25, 2008, the disclosure of which is expressly incorporated herein.

### BACKGROUND OF THE INVENTION

This application relates to a methodology for identifying engine fuel savings from periodic engine washings for gas turbine engines.

It is known that aircraft engines can benefit from being washed periodically. Among the benefits is better fuel efficiency.

No methodology is known that can calculate or estimate engine fuel savings from periodic washing.

There are companies that will now certify carbon emission reductions made by industrial companies, and provide so-called “carbon credits.” These “carbon credits” actually have value, and may be transferred on open markets. However, this feature has never been applied to the cleaning of engines.

### SUMMARY OF THE INVENTION

A method comprises the step of certifying a savings in carbon emission based upon a cleaning of a gas turbine engine.

These and other features of the present invention can be best understood from the following specification and drawings, the following of which is a brief description.

### BRIEF DESCRIPTION OF THE DRAWINGS

FIG. 1A is a schematic view of a method of gathering and utilizing CO₂ savings after aircraft engine washings.

FIG. 1B is a schematic of a system for performing the method of FIG. 1A.

FIG. 2 is a graph illustrating exemplary fuel savings with engine washings.

FIG. 3 illustrates potential fuel savings based upon frequency of wash.

FIG. 4 illustrates potential fuel savings across flight cycles.

### DETAILED DESCRIPTION OF THE PREFERRED EMBODIMENT

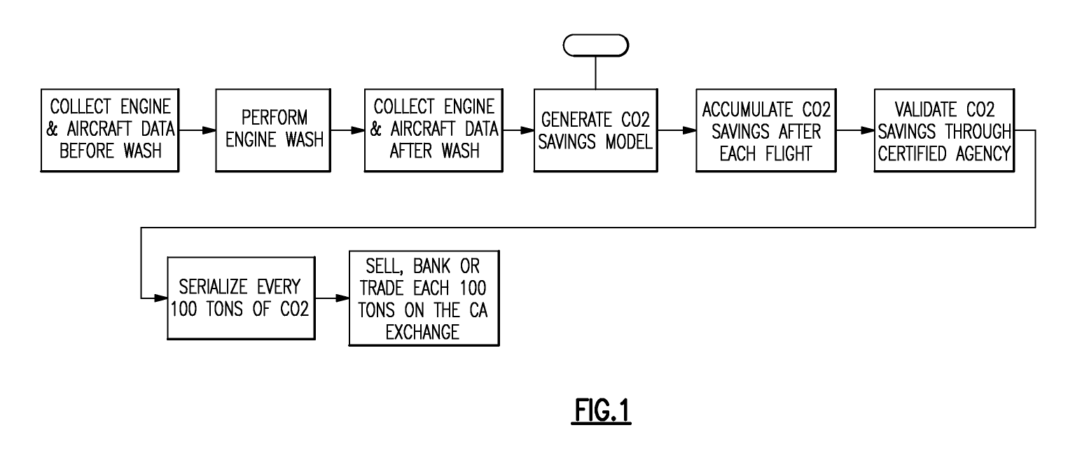

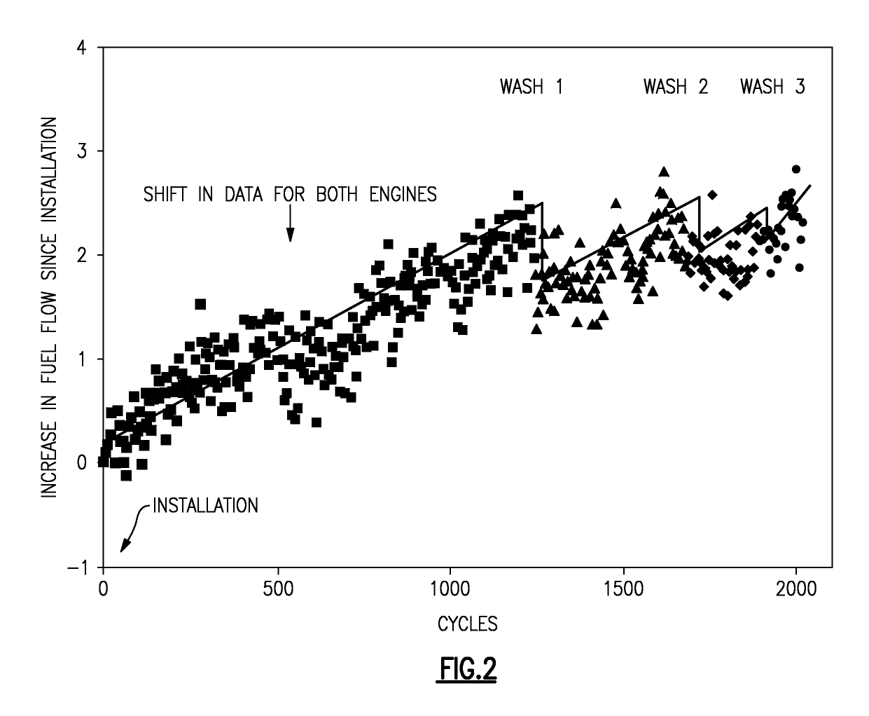

FIG. 1A is a flow chart for a method of quantifying the benefits of engine wash for aircraft engines. In co-pending patent application Ser. No. ______ entitled “Tracking of Engine Wash Improvements,” filed on even date herewith, other inventions covering the quantification of fuel savings based upon engine washing are claimed. These are also shown in the FIG. 1A flowchart.

As shown in FIG. 1A, an engine wash is performed, and engine and aircraft data, such as various operational data, is collected both before the wash and after the wash. FIG. 1B shows an aircraft 20 having jet engines 22. An onboard system 24 analyzes performance of aircraft and jet engine functions, and can periodically submit that information to a computer 26, which may be a remote computer. This transfer could occur over any known method. A savings model for the fuel savings with each wash is developed based upon this collected data. The CO₂ savings resulting from the reduced fuel use or flow is determined. Once the CO₂ savings per wash and per flight are known, the amount of CO₂ saved each flight can be calculated and accumulated over some time period. At some point, the CO₂ savings can be validated through a certifying agency. Once certified, the CO₂ savings can be sold, banked or traded on a CO₂ savings exchange.

The way the engine fuel savings are determined is disclosed by a particular method. However, other methods for predicting engine fuel savings, or actually calculating engine fuel savings due to a wash will come within the scope of this invention.

An engine wash can be performed using any method. One method is EcoPower® engine wash, available from Pratt & Whitney. This method uses atomizing nozzles mounted in the engine inlet to spray a cleaning fluid such as heated, purified water at a specific range of droplet sizes for cleaning the core of the engine, while cleaning the fan using another nozzle or nozzles. Other methods typically used in industry include shepherd's hooks and the fire hose method. Effectively cleaning the engine results in less energy (fuel) required to produce the same amount of thrust, and resulting generally in a better performing engine. The amount of fuel consumed per pound of thrust is called the engine's Thrust Specific Fuel Consumption or abbreviated as TSFC. TSFC is measured at the Corrected Fuel Flow/Corrected Thrust. Applicant has determined a method of accurately assessing the improvement in TSFC resulting from the engine wash(s). The result can be applied to the typical flight cycle fuel burn for an operator and the amount of fuel savings can be calculated.

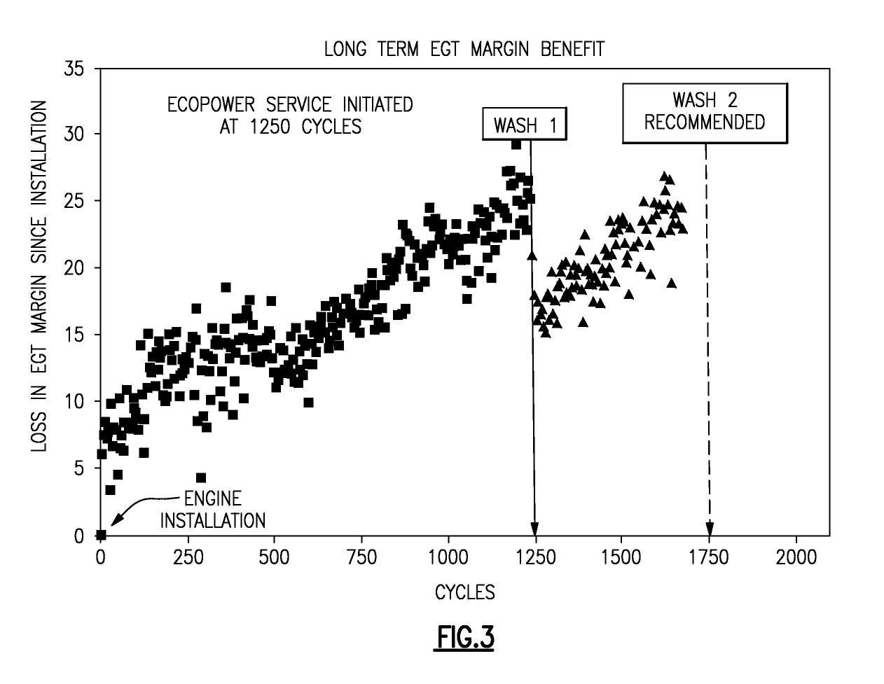

The disclosed method can be used for a single engine, all engines on a particular aircraft, or a fleet of engines. For example, a single engine fuel burn analysis can be made with a statistical sample of data obtained before and after the wash to evaluate the performance improvement. For a fleet, all or a sufficient sized sample of the engine wash results can be analyzed and averaged to apply the TSFC improvement realized. Using the TSFC results for that specific engine and aircraft model, along with an identified Contamination Interval (CI) and a Wash Interval (WI), the effects of engine washing on fuel burn reduction can be accrued. As shown in FIG. 2, washes decrease fuel use, but over subsequent cycles, the savings deteriorate over time/engine cycles, producing a “saw-tooth” data trend as engines are washed, then recontaminate, and the cycle repeats. Once the fuel burn reduction is known, the amount of CO₂ emission saving can be directly calculated resulting from the known ratio of CO₂ created per mass of fuel consumed.

Engine data is required to assess the performance benefit of the engine wash. Data collection can be accomplished in many ways; however the disclosed method is through an automated system 24 in FIG. 1. One such system is aircraft communications and reporting system or “ACARS”. Data is collected on the aircraft at flight conditions such as take-off (normally used for EGT Margin and rotor speed trending) and stabilized cruise (normally used for trending the fuel burn, EGT, rotor speeds, and pressure deterioration). Aircraft data acquisition systems are designed to collect the data for example from the aircraft systems and engines electronic engine control (EEC) at one or more repeatable points in a flight profile. For example, the take-off data is typically captured during take-off at the highest EGT point. Cruise data is normally captured when the software assesses the data is at the most stable point of the cruise. This may be taken as a point when there have been no recent changes in the engine power setting or aircraft configurations. The legacy aircraft data systems typically take this data and organize them into reports; for example a take-off or cruise report. Newer aircraft have frames of data taken at various times throughout the flight, and most aircraft collect continuous data that can be used in lieu of these reports.

This flight data can then be automatically fed to the automated system for distribution to ground stations that process the data. The ground station, such as the ones typical in the aerospace industry, validates the data and sends it to an application program to be processed and statistically trended.

Alternatively, aircraft and engine data can be provided directly from an operator using their own engine data trending program, in any form that allows statistical data analysis. Alternatively, the raw aircraft and engine data can be provided by the operator and normalization of the data can be performed, e.g., manually or otherwise, to assess the changes in engine operation over time. Those skilled in the art would recognize that there are many ways to receive and process aircraft and engine data and some are described here but others are possible and those are included in this patent.

Both take-off and cruise data are gathered in a disclosed embodiment. Typical parameters are listed below. A minimum set of data points before and after the wash should be provided to enable calculation of a statistically significant result. This minimum number may be thirty, for example. Alternatively to directly using a trending system, numeric values for each data point can be provided in Excel or other electronic text format. Trend plots alone are preferably not used because the values can not be numerically calculated. The trending programs typically outputs corrected, normalized results that compare the engines performance to a baseline and provide the difference from that baseline, known as the “delta”, to show how the engines performance changes over time. The “delta” numeric values are trended values, but are not smoothed (numerically averaged over multiple flight cycles). Smoothed data will not facilitate statistical analysis of a instantaneous trend shift such as that which occurs as a result of engine water wash. Data for all engines on the aircraft is requested (though not required). The data for the unwashed engine(s) is used for comparative analysis and can help eliminate variation that is not well normalized by the engine trending software. Examples of the gathered data would be:

Take-Off Data: Date, Time, EPR, Total Air Temperature (TAT), Mach Number (MN), Pressure Altitude, EGT, Fuel Flow (WF), N1, N2, and calculated EGT Margin.

Cruise Data: Date, Time, TAT, MN, Pressure Altitude, EPR, N1, EGT, WF, EGT Delta, and WF Delta.

In addition to these parameters, cycles since installation or overhaul and cycles since last wash can provide insight to the level of engine contamination, while N1 Delta, N2 Delta, and any additional gas path delta and raw parameters can provide greater insight to the engine performance analysis.

The raw data typically requires processing to normalize the data and develop calculated parameters, such as the engine's exhaust gas temperature (EGT) Margin or cruise Fuel Flow Delta. Engine trending programs, such as Pratt & Whitney ADEM (Advanced Diagnostics and Engine Management) and EHM (Engine Health Management) or General Electric's SAGE perform this function, normalizing the data to standard conditions for ambient temperature and pressure, and remove differences due to engine power setting, bleed loads, vane scheduling, and other factors that cause variation. This results in a very accurate output of trended temperatures, pressures, and other engine specific parameters. On some more modern aircraft data systems there is an output of calculated parameters that is included in the reports and data streams.

Typical calculated values used for analysis of the wash performance at take-off would be EGT Margin, N1 Margin, N2 Margin and Fuel Flow (WF)

Typical calculated values used for analysis of the wash performance at cruise would be Fuel Flow Delta, EGT Delta, N1 Delta, N2 Delta, Turbine Expansion Ratio Delta, LPC Pressure Ratio Delta, HPC Pressure Ratio Delta, T3 Delta and T25 Delta.

While a particular formula is utilized that looks at each of these several values, it may also be possible to look at other values, or fewer values. The most heavily influential value is the Fuel Flow Delta. EGT Delta and EGT Margin may also be relatively important. Thus, it may be possible to simply look at a few components, and still gain a relatively accurate prediction.

Using the calculated parameters, the performance gain of the wash is analyzed for each engine or a statistically significant sample necessary to assess the performance shift as a result of the wash. From the shifts in the normalized performance data, the effect of changes in module efficiency and flow capacity based on engine specific numerical models can be determined and the resultant Thrust Specific Fuel Consumption (TSFC) improvement can be quantified.

As one example of the disclosed method, the following steps can be taken:

A) Obtain 50 individual cruise and takeoff data points before the wash and 50 data points following the wash for each engine on the aircraft.

C) Calculate the variation of the 50 data points prior to the wash and determine the appropriate threshold for omitting outliers. For example, data that is greater than 2 times the standard deviation from the mean could be considered outlying data.

D) Omit data that is greater than the variation threshold from the mean of the 50 points before the wash.

E) Omit data that is greater than the variation threshold from the mean of the 50 points following the wash.

F) Of the remaining data, select 20 points before the wash and 20 points following the wash.

G) Calculate the difference between the average of the 20 points following the wash and the 20 points prior to the wash. This difference will be defined as the “delta_delta”.

H) This “delta_delta” is calculated for EGT Margin, and cruise trended parameters, especially fuel flow delta. From the “delta_delta”, and using known relationships between these measured shifts and the change in TSFC, the TSFC can be calculated.

I) The relationship between take-off EGT Margin, cruise fuel flow and EGT are normally highly correlated, and can be used as an indicator for erroneous data. If a significant difference exists relative to expectations, the erroneous points or engine results are eliminated from the data.

J) The Fleet Average TSFC is evaluated based on the average of performance changes measured due to individual washes. This is necessary due to the variable nature of engine contamination. The averaging of the data gives a very accurate assessment of the overall average improvement.

K) The average TSFC improvement can be used to evaluate the impact of engine wash improvements on fuel burn, and thus CO₂ reduction.

To model the fuel burn for a mission of a particular aircraft and engine type the operator's average mission characteristics should be obtained. This can be done for a fleet of aircraft, a single aircraft, or sub-fleet. The normal data utilized is the cycles and hours operated per year. This, along with the aircraft and engine specific information allows an aircraft performance model to be run to estimate the typical fuel burn for one average cycle.

It may also be possible to actually track values over time in operational systems, rather than relying upon the precise calculation of this application.

Using the data for the fleet average utilization, an engine specific aircraft performance model is used to estimate the average fuel burn for a given mission. The typical method is to use the model that is calibrated to actual “in service” results. The model outputs the fuel burn by flight leg for that of one average flight cycle. Models are normally developed for new engine and aircraft performance. The fuel burn model adds in a fleet average deterioration factor to account for actual service levels.

Using the output from the fuel burn model, the effect of engine washing is applied to the fuel cost per flight cycle and extrapolated to the required fleet. This is performed using the following method. The method incorporates the effects of the initial gain in fuel burn and then the rate of recontamination and the interval at which washes are performed.

Wash Interval (WI): Cycle interval at which engine washing is performed.

Contamination Interval (CI): Cycles at which the engine becomes “fully contaminated,” evidenced by flattening of the curve for performance gain versus cycles from engine wash. This is generally between 700-1200 cycles, although it can vary depending on contamination from type of route flown, congestion and other factors that influence the type and exposure of an engine to contamination.

Wash Interval Factor (WIF): The factor that applies the percentage of the TSFC improvement resulting from engine washing, accounting for wash frequency and engine recontamination rate. The factor is applied to initial gains and the WI and CI to calculate the average fuel burn or CO₂ benefits. Thus, if an engine is washed at ½ the CI the benefit is calculated to be an average of 75% of the initial fuel burn shift from the wash. On the other hand, if the full interval CI is used (full contamination), the benefit would be 50% of the initial shift.

$$WIF = 1 - \frac{1}{2} \times ( \frac{WI}{CI} )$$

The WIF is applied to the average fully contaminated wash TSFC gain to establish the average TSFC experienced throughout the year for the fleet or a single engine. The WIF accounts for the effect of recontamination on the average improvement in fuel burn as a result of the wash.

$$AnnualFuelReduction = TSFC \times WIF \times \frac{AvgEngineFuelBurn ( lbs )}{cycle} \times \frac{Cycles}{year} \times \# Aircraft \qquad Equation$$

Then: the annual fuel reduction

$$\times 3.17 \frac{lbm {CO}_{2}}{lbmFuel}$$

would be equal to the CO₂ emission reduction. The 3.17 factor is a relationship between fuel burn and CO₂ emission. Other factors may be used.

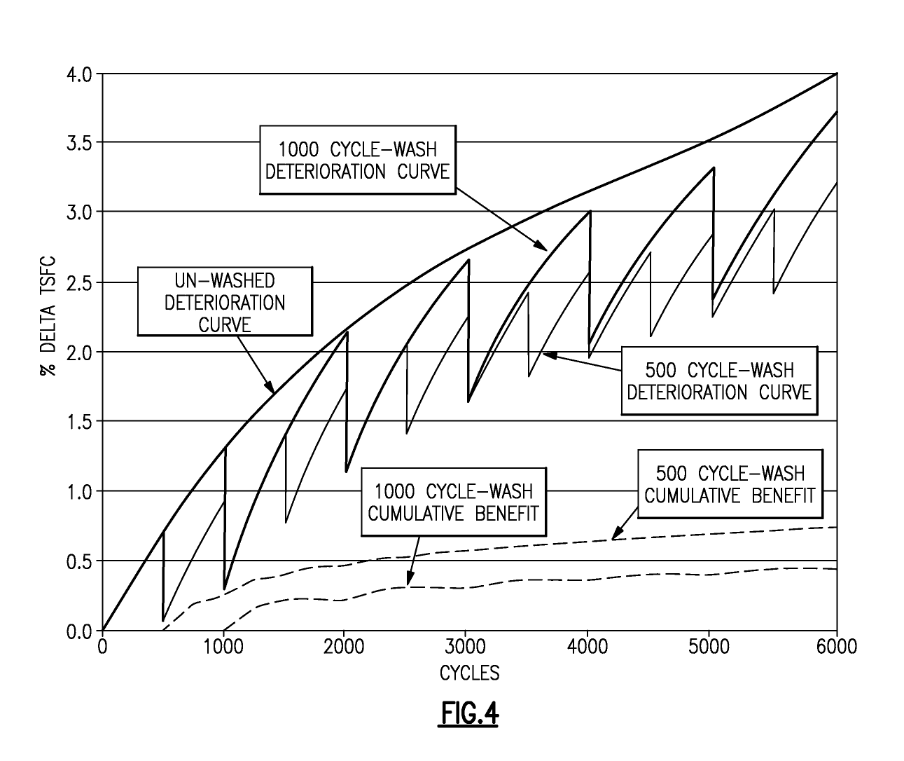

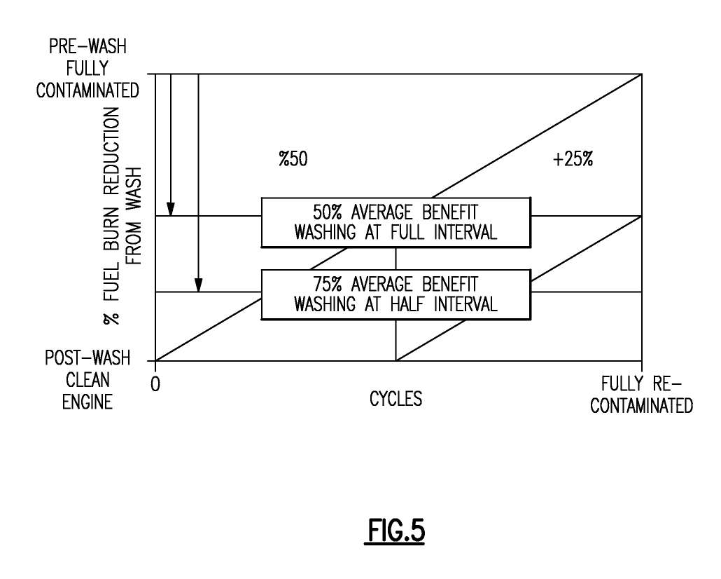

FIG. 3 shows another feature of this invention. As can be appreciated, once the trending data is known, a recommended interval for washes can be determined. More detailed information is provided in the chart of FIG. 4, which can show the total accumulated savings that can be realized by shortening the wash interval. By utilizing information such as is available from the FIGS. 3 and 4 charts, it is possible to select a wash interval that is most cost effective. Of course, the information and prediction of wash intervals can be performed by any number of other ways of conveying the information.

While the above disclosure has concentrated on a method, the present invention would extend to a computer-readable medium, which is programmed to perform the method, and in addition, a system such as the computer 26 that can take in the information and provide the output as disclosed.

As shown in FIG. 1, a display 27 of the information can be made on the computer 26. The display can look like the FIG. 2, FIG. 3, or FIG. 4 information, or any other information. In addition, such information can be printed as an output. Further, the information based upon the fuel savings can be translated into a reduction in CO₂ emissions and then certified for carbon credit.

Returning to FIG. 1, the CO₂ savings can be sent to certifying agencies as an example Det Norske Veritas (DNV), ICF International Customers. The credits will be verified by the certifying agents, and can then be sold on carbon markets. As an example, the European Climate Exchange (ETS) and Chicago Climate Exchange (CCS). Potential customers could be airlines, power plants, cement plants, etc., which need to be better able to meet their emission quotas.

It should be noted that a computing device can be used to implement various functionality, such as that attributable to the computer 26. In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the computing device is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

While the above description is shown tied to an aircraft jet engine application, other turbine engine applications, such as ground-based applications for generating electricity would also benefit from this invention.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A method comprising the step of:
certifying a reduction in carbon emission based upon a cleaning of a gas turbine engine.

2. The method as set forth in claim 1, wherein the certified carbon emission reduction is then sold as a carbon credit.

3. The method as set forth in claim 1, wherein the certified carbon emission reduction is summed over a period of time.

4. The method as set forth in claim 1, wherein a step of determining a carbon emission reduction is based on a decrease in fuel use due to the cleaning.

5. A method comprising the steps of:
(a) periodically washing a gas turbine engine;
(b) determining a fuel use reduction based on said periodic cleanings;
(c) sending said determined fuel use reduction to a certifying agency to certify a carbon emission reduction; and
(d) selling a carbon credit associated with said certified carbon emission reduction.
